(19) United States
(12) Patent Application Publication
(10) Pub. No.: US 2007/0078850 A1
(43) Pub. Date: Apr. 5, 2007

(54) Commerical web data extraction system

(75) Inventors: Imran Aziz, Seattle, WA (US); Ji-Rong Wen, Beijing (CN); Yan-Feng Sun, Beijing (CN)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/240,381

(22) Filed: Oct. 3, 2005

(51) Int. Cl. G06F 17/30

(52) U.S. Cl. 707/6

(57) ABSTRACT

A system and method for delivering detailed product information to a user in response to a request for a product is provided. The delivered product information can include products identified by crawling web sites and extracting product information. The detailed information can include the name of the product, a picture of the product, the price of the product, a description of the product, and/or other information specifying a product for sale.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Many types of commercial goods are now available via the World Wide Web. Some conventional web sites allow a user to browse products from a single company or distributor. Other conventional sites can allow a browser to view products from one or a few predetermined sites or commercial locations.

What is needed is a system and method for allowing a user to view sale and product information from a variety of product web sites in a single location. The system and method should allow a user to view offers for sale of any type of desired product. Additionally, the system and method should provide a user with detailed information about available products in response to a product request.

### SUMMARY

In an embodiment, the invention provides a system and method for extracting detailed product information for products that are available from an internet website and delivering the product information in response to a product request. The product information provided to the users can be based on information provided by a retailer, or the information can be obtained by searching web sites and extracting the product information. Products matching a query can then be provided in a gallery view to allow for easy comparison by a user.

### BRIEF DESCRIPTION OF THE DRAWINGS

FIG. 1 is a block diagram illustrating an overview of a system in accordance with an embodiment of the invention.

FIG. 2 is block diagram illustrating a computerized environment in which embodiments of the invention may be implemented.

FIG. 3 is a flow chart illustrating a method for performing a commercial offer search according to an embodiment of the invention.

FIG. 4 is a flow chart illustrating another method for performing a commercial offer search according to an embodiment of the invention.

FIG. 5 schematically shows a system for integrating a commercial offer search with a keyword search engine according to an embodiment of the invention.

FIG. 6 schematically shows a system according to an embodiment of the invention for performing a commercial offer search.

### DETAILED DESCRIPTION

I. Overview

In an embodiment, the invention includes a system and method for providing detailed commercial offer information to a user in response to a request for a product, service, or other type of commercial offer. For example, when a product request is received from a user, the user is provided with detailed information about product availability from a variety of sellers. The detailed information can include information from retailers who have agreed to provide product information. The detailed information can also include information obtained by crawling publicly available web sites and extracting product information from the crawled web sites. The detailed information can include the name of the product, a picture of the product, the price of the product, a description of the product, and/or other information specifying a product for sale.

II. Identifying Commercial Offer Pages

In an embodiment of the invention, the method begins by identifying potential pages that contain a commercial offer. For convenience, the method will be described with reference to “product pages”, or pages where the commercial offer is an offer for sale of a product. However, the description that follows applies generally to any type of goods or services that can be offered by a merchant or other commercial entity.

As a preliminary step, a web crawler can be used to pre-search publicly available web documents. During a pre-search, a group of searchable documents is crawled and searched to catalog the type and content of each document. A pre-search can occur at any convenient interval, such as once a day or once a week. The group of searchable documents can represent any convenient grouping. In an embodiment, documents from web locations in a specific country can be pre-searched. In another embodiment, documents from a known commercial site can be pre-searched to obtain information about available products listed on the site. In still another embodiment, all searchable documents available via the Internet can be pre-searched to identify and classify product pages. In such an embodiment, the pre-search for product information can take place as part of a pre-search for a conventional search engine.

For each document in the group of searchable documents, the document can be classified as a product or non-product page. A product page is a document containing information about one or more products. Product pages can include documents describing a product for sale, documents containing a special offer for a particular product, documents describing accessories for a product, and other types of documents describing information related to a product.

Product pages can be identified by any convenient method. In an embodiment, a document can be classified by searching the document for product characteristics, such as a price for a product, a product description, or an image of a product. Alternatively, a product page can be identified based on the presence of a link that indicates an item is for sale, such as a link labeled “buy now” or “add to shopping cart.”

In an embodiment, product pages can be identified and/or classified by first breaking down a large number of available documents into smaller groups or “chunks”. The smaller groups of documents can each contain one or more documents. The documents in a small document group can be a related group of documents, such as a documents that are organized under a common parent document on a web site, such as documents organized under “microsoft.com.” In another embodiment, one or more web sites may have a similar format or structure that can be specifically targeted for product page identification and extraction. For example, “amazon.com” is a parent site for a number of web pages having a similar format that also contain product listing. A web site (or sites) having a format or structure that can be targeted for product identification and extraction can be referred to as a “head site.”

III. Extracting Commercial Offer Records

After breaking down the available documents into chunks, the documents in each chunk are analyzed to identify product pages. In an embodiment, the analysis begins with the first document in the document group. For a group of documents that are related to one another, the first document can be the parent document or some other document logically related to the remaining documents in the grouping. HTML and meta information is then extracted from the document. The HTML and meta information can then be analyzed to classify the document, for example, as a product or non-product page. In an embodiment, the HTML and meta-information data is analyzed to identify any indications of a price, such as a price identifier or a phrase/snippet of words indicating a price or product for sale. The price identifier or pricing phrase can be in the text of the document or in a hyperlink in the document to a separate document or web location. In another embodiment, the document can be classified as a product or non-product document based on the presence of words, phrases, or other document features that are commonly found on product pages. In such an embodiment, a search engine can be trained to identify product pages. A test group of documents can be reviewed by humans to develop a training set of documents. The parameters of a search engine can then be tuned based on the product versus non-product judgments from the training documents. In still another embodiment, the parameters of the search engine can be tuned to separately classify a subset of product documents, such as product documents containing special offers or product documents describing accessories for a product.

If a document is classified as a product page, product information elements corresponding to one or more products available on the product page is extracted. The extracted information for a product can include the product name, model, manufacturer, price, any special offers, ratings and/or reviews of the product, or an image of the product. Extracted product information that is related to a single product can be referred to as a product record.

Preferably, product information elements are extracted automatically by an entity extractor. Some information elements can be extracted by identifying common keywords associated with a certain category, such as known brand names. Other information elements can be identified for extraction by training the entity extractor. First, a known set of training documents are reviewed by humans to identify various types of product data. The training documents are then used to optimize parameters in the entity extractor so that various information elements (brand, price, image, rating, etc.) are extracted correctly.

In a preferred embodiment, multiple sets of parameters for an entity extractor are available to allow for different extractor optimizations. In such an embodiment, one or more parameter sets can be developed that are targeted for use on a group of documents organized under a specific parent document, such as the head site for an individual retailer that has a large and/or desirable collection of products offered on the web site. The targeted parameter sets can be optimized based on the particular format used by the individual retailer. Using the targeted parameter sets allows for improved extraction from commercial sites that are known to have large and/or desirable product collections. In an embodiment, the parameter set used by the entity extractor is selected each time a new chunk of documents is analyzed. If parent document corresponding to a particular parameter set is contained in the chunk, product information for all product pages in the chunk can be extracted using the targeted parameter set. Otherwise, a default parameter set can be used. In another embodiment, the documents within a chunk may not all share the same parent document. In such an embodiment, a new extractor parameter set can be selected as needed based on the correspondence, if any, of each document in the chunk with a targeted parameter set. The extraction parameter set to use for a particular document can be selected by analyzing one or more characteristics of the document (or parent document), such as searching the document for a keyword or by analyzing the URL (universal resource locator) for the document.

The above procedures can be repeated to produce a product record for each product contained on an identified product page. The resulting product records can then be converted into any convenient data format, such as XML. This allows the product records to be used by a search engine that is targeted to providing commercially available products. After converting the product records into XML format, the product records can be stored in a database. Alternatively, the data contained in the product records can be incorporated or overlaid as meta-data into an existing web document index to allow for searching of the product records.

In an embodiment, commercial data extracted from a document can be used to form product records having one or more of the following categories: 1) The name of the commercial offer; 2) A description of the product or service that comprises the commercial offer; 3) The merchant offering the product or service; 4) At least one price for the product or service; 5) One or more special pricing offers currently available for the product or service; 6) A URL for an image related to the commercial offer; 7) A classification or categorization of the product or service based on the offering Merchant's taxonomy scheme (for example, an ornamental lamp could be classified by a merchant as being in the category/subcategory “Home furnishings/Home decor”); 8) The manufacturer of a product (publisher if the product is a book); 9) The model number or universal product code of the product; 10) The type of document where the commercial offer was found, such as an offer listing document, an offer details document, or a document containing mixed types of information; and 11) Locale (geographical) information regarding the document containing the commercial offer.

After extracting product records from a document, the product records can be converted into a format that can be easily searched using an available search engine. This allows a commercial offer to be “ranked” in response to a commercial offer query in a manner similar to how a web document is ranked by a search engine in response to a search query. In an embodiment, metadata from the product records can be overlaid on to an existing web document index to allow for commercial searching. In such an embodiment, the metadata could represent keywords, the web document index could be an inverted index for searching, and the product records for a single document could represent the “document” associated with the metadata keyword. In another embodiment, the product records can be converted into an HTML format to allow searching by a conventional web search engine. In such an embodiment, converting the product records can include using the data in the product records to populate corresponding fields in an HTML format document. For example, the name of the product, service or other commercial offering can be used to populate the title field of an HTML document. A description for the commercial offering can be used as the body text of the HTML document. The conversion can also allow population of other fields not directly related to a product record. For example, a product record quality can be determined for a commercial offering, possibly based on the number or type of product records available after extraction. This product record quality can be used to populate a page quality field in the HTML document.

In an embodiment, after converting the product records for a product into an HTML document, the document can be pre-searched to form a convenient data structure for searching, such as an inverted index of keywords. Preferably, the index or other search data structure can be adapted for commercial offer search, such as by including known merchants and products as searchable words or phrases.

By converting the product records and information generated from the product records into a searchable format, such as an HTML format, the ranking algorithm of a search engine can be used to rank the available commercial offers corresponding to commercial offer query. The rankings can be used, for example, to determine the order of display for commercial offers corresponding to a product query and/or whether a commercial offer should be displayed at all. The commercial offer rankings can also be further improved by modifying how the search engine is used. For example.

In addition to extracting product records, the pre-search can also be used to construct an inverted index of words and/or word phrases. The inverted index can be used to correlate product records with words or phrases found in the product records. This allows product records related to a search term to be quickly retrieved in response to a user product search request. Alternatively, other data structures can also be constructed to assist in organizing the product data for improving response time to user requests.

In an embodiment, the product records found during a pre-search can be further processed and classified prior to being stored in a database. In such an embodiment, the product description and other information elements in the product record are categorized in a detailed way to allow for comparisons between products. For example, based on keywords or other information extracted by the entity extractor, the product can be classified in a product category, such electronics, automotive, etc. Depending on the extracted information, the product may also be able to be placed in a narrower subcategory, such as a DVD player or a multi-disc DVD player. The additional processing can also be used to create a uniform format for information elements extracted by the entity extractor. For example, the extracted information elements can be analyzed and used to fill in a template of available features for an item. This allows comparison of available features for two or more items of a similar type.

In an embodiment where product information is categorized, the categorized information can be searched using a structured query request. In a structured query request, the product information can be searched using a query that asks for one or more keywords in a specific category. For example, structured queries can be submitted to request information about automobiles of a particular brand or DVD changers that can store more than a specified number of discs. In an embodiment, a user can submit a structured query by specifying both a query category and a keyword associated with the query category within the query. In another embodiment, a user interface can be provided to facilitate submission of a structured query. For example, a drop-down menu can be provided containing a list of potential query categories. A user can then select a query category from the list and specify a keyword to be found in the selected category. In still another embodiment, similar products (or commercial offers) could be clustered and annotated with hash values. In such an embodiment, the a structured query request could be used to identify similar items based on distances between hash calculations stored per record for the items.

In still another embodiment, the product records extracted from the documents found by crawling web sites can be combined with other product records provided by an information stream received from a seller or retailer. In such an embodiment, one or more sellers can provide an information stream containing information elements about products available for sale. These provided information elements can be converted into product records and aggregated with the other product records.

IV. Display of Results

After analyzing the results of the pre-search, the resulting product records can be used to form responses to user product requests. In an embodiment, a user can submit a product request as a keyword search request to the commercial product search engine. For example, a user could submit a search request for a particular brand of electric guitar by using “<brand>electric guitar” as keywords. The product search engine would then return offers to sell products matching the search.

In another embodiment, rather than simply providing a listing of web sites, the product search engine provides the user with a gallery that displays various information elements from the product records. For example, the initial gallery can include the price of each product, a product picture, and a link to the commercial web site offering the product. Other information elements can also be presented, such as a comparison of product features. The displayed results can also be refined by organizing the results based on various criteria, such as store name, product price, or whether the product is being offered by a confirmed merchant or a non-confirmed merchant.

V. General Operating Environment

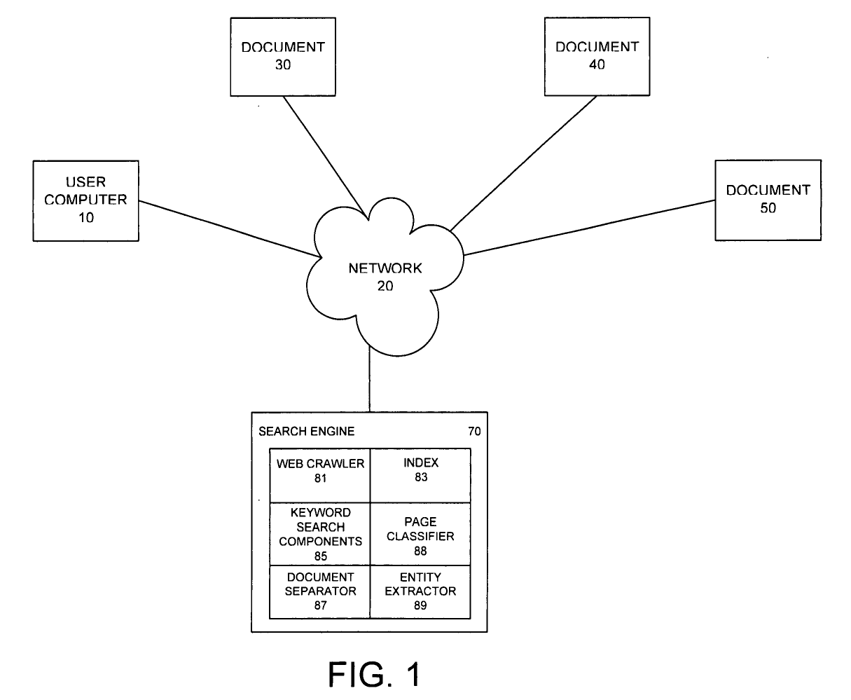

FIG. 1 illustrates a system for performing commercial product searches according to an embodiment of the invention. A user computer 10 may be connected over a network 20, such as the Internet, with a search engine 70. The search engine 70 may access multiple web sites 30, 40, and 50 over the network 20. This limited number of web sites is shown for exemplary purposes only. In actual applications the search engine 70 may access large numbers of web sites over the network 20.

The search engine 70 may include a web crawler 81 for traversing the web sites 30, 40, and 50 and an index 83 for indexing the traversed web sites. The search engine 70 may also include a keyword search component 85 for searching the index 83 for results in response to a search query from the user computer 10. In an embodiment, keyword search component 85 can include a structured query component for matching a product record with a search query based on both a query category and an associated keyword. A document separator 87 can be included to separate out desired HTML and meta information from documents found by the web crawler. The search engine 70 may also include a page classifier 88 for classifying pages as product or non-product pages. Additionally, search engine 70 can include an entity extractor 89 to extract information elements about a product from a product page, such as brand name, price, product reviews, and images of the product. The extracted information can be stored in a database or index structure (not shown), possibly after further processing. Alternatively, entity extractor 89 can include a display component for displaying information elements extracted from one or more product records in a gallery.

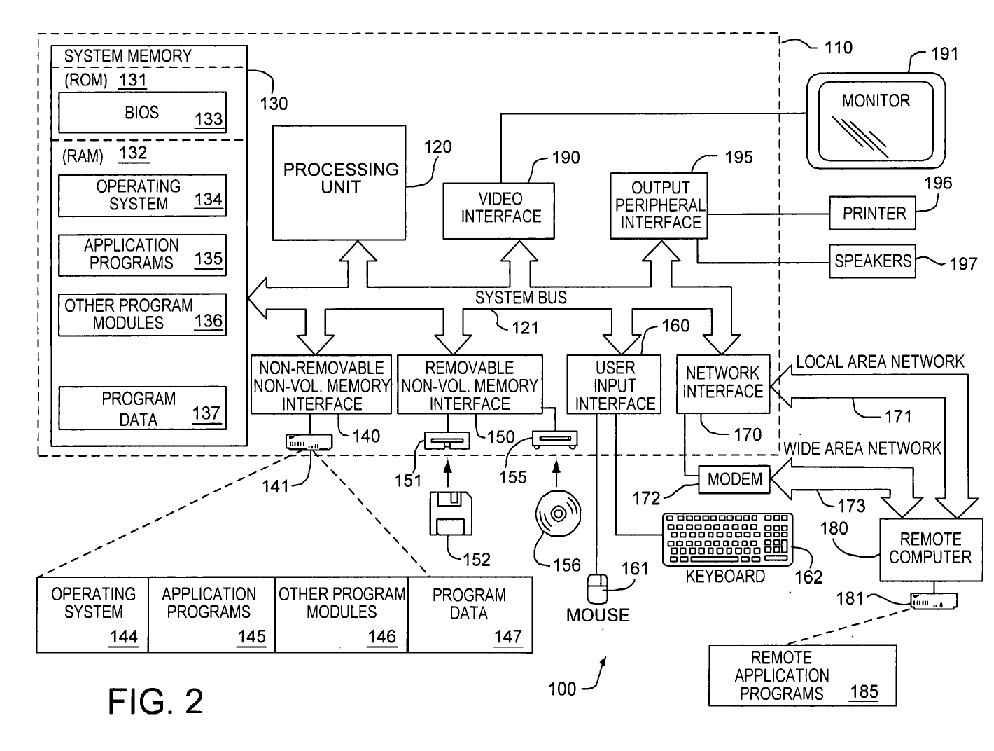

FIG. 2 illustrates an example of a suitable computing system environment 100 for implementing commercial product searching according to the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

VI. Exemplary Embodiments

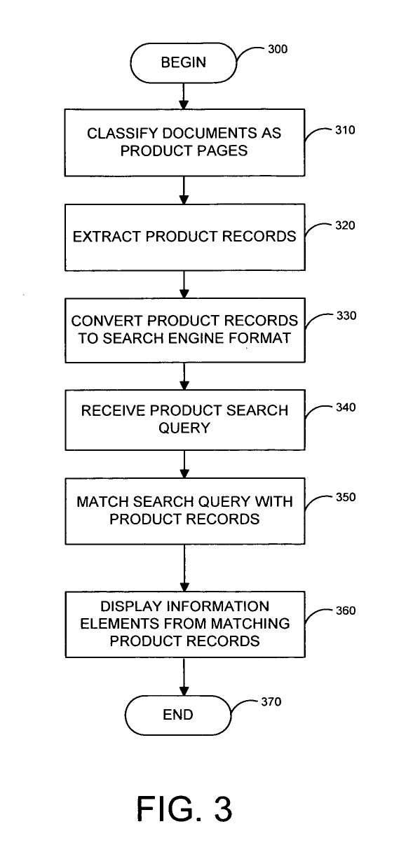

FIG. 3 provides a flow chart of a method for responding to a commercial product search query according to an embodiment of the invention. In FIG. 3, the method begins with classifying 310 one or more searchable documents as product or non-product pages. Product records are then extracted 320 from the documents classified as product pages. The extracted product records are converted 330 into a data format that is usable by a product search engine. A product search request or query is then received 340 from a user. The keywords in the search request are used to match 350 the product search request to product records extracted from product pages. Information elements from the extracted product records matching the search request are then displayed 360 to the user as the results of the product search.

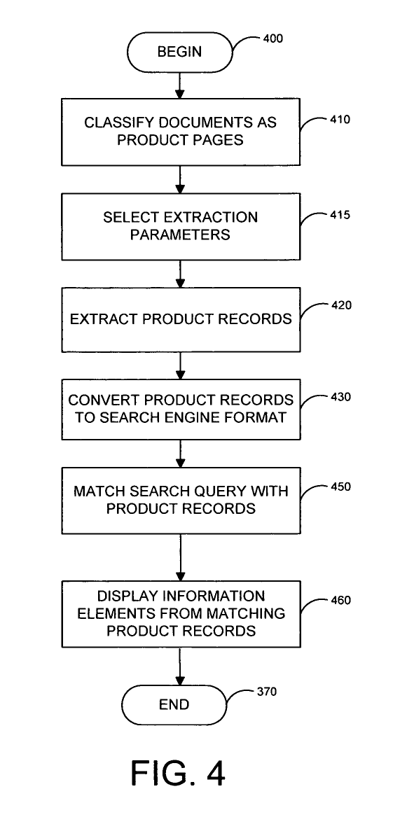

FIG. 4 provides a flow chart of a method for performing a commercial product search according to an embodiment of the invention. In FIG. 4, the method begins by receiving 410 a chunk of documents organized under a common parent document. A set of extraction parameters is selected 415 based on one or more characteristics of the parent document, such as the identity of the commercial retailer corresponding to the parent document. Product records are then extracted 420 using the selected extraction parameters. After converting 430 the product records into a data format for use in a product search engine, one or more of the product records is matched 450 to a product search query. A plurality of information elements is then displayed 460 from each matching product record in response to the product search query.

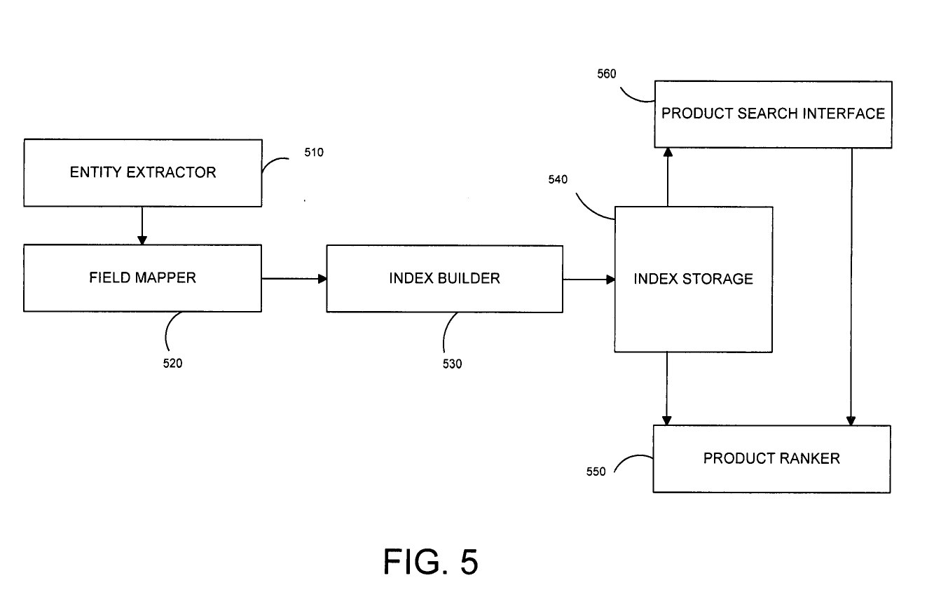

FIG. 5 schematically shows an example of a system for converting product records (or other commercial offer records) into a searchable index. Entity Extractor 510 can be used to generate product records based on documents containing product offers. The product records are passed to field mapper 520 to create searchable HTML documents. In an embodiment, each HTML document corresponds to only one product. The HTML document can then be pre-searched by an index builder 530 to create an inverted index or other data structure to facilitate responding to a product search query. The index created by index builder 530 can be stored in an index storage 540. Product search interface 560 can be used by a user to input a product search query. The product ranker 550 ranks potential product matches to the query based on the data in index storage 540.

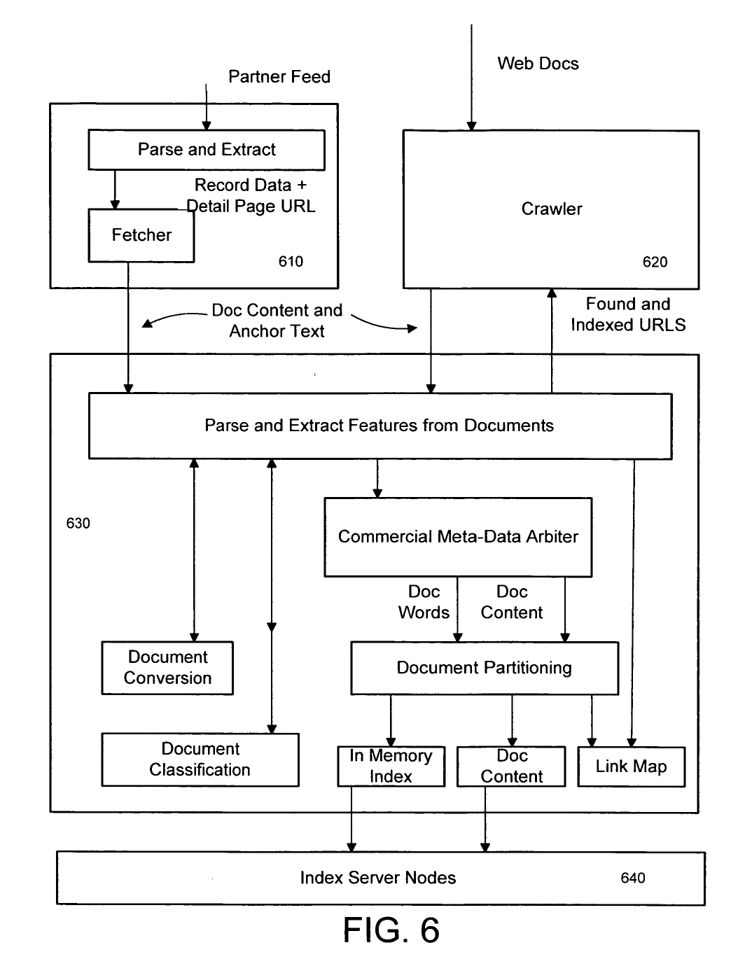

FIG. 6 schematically shows an example of an overall system for searching documents for products (and other commercial offers) according to an embodiment of the invention. In FIG. 6, a commercial feed interpreter 610 can be used to parse and extract product information from a feed provided by a merchant or other third party. The feed containing the commercial offers can represent a data feed having a known format that is provided by the merchant. The commercial feed interpreter 610 first parses the commercial offer feed to extract any commercial offer documents contained in the feed. A fetcher is then used to deliver the extracted information to index builder 630. Commercial offer data can also be obtained by crawling web documents using crawler 620. The crawlers works with index builder 630 to identify documents containing products and other commercial offers.

As documents containing product and other commercial offers are identified, index builder 630 parses the documents and extracts any commercial offer information. Preferably, the documents can be classified according to the type of information in the document. The information in the documents can also be converted into a searchable document format. Additionally, the documents can be partitioned and categorized. For example, the documents can be indexed using a keyword or other type of index. Content related to a single offer can also be stored in a single logical location to allow for easy retrieval of related product information. Any links to related pages can also be noted for a given commercial offer. After building the index, the information extracted and/or generated by index builder 630 can be stored in one or more index nodes 640.

The principles and modes of operation of this invention have been described above with reference to various exemplary and preferred embodiments. As understood by those of skill in the art, the overall invention, as defined by the claims, encompasses other preferred embodiments not specifically enumerated herein.

What is claimed is:

1. A method for performing a document search, comprising:
identifying one or more documents as commercial offer pages;
extracting a commercial offer record from each of the one or more commercial offer pages;
receiving a commercial offer search request;
matching the commercial offer search request with a plurality of extracted commercial offer records; and
displaying a plurality of information elements from each matching commercial offer record.

2. The method of claim 1, wherein matching the commercial offer search request comprises matching one or more keywords in the commercial offer search request with one or more commercial offer records corresponding to the keywords.

3. The method of claim 1, wherein the received commercial offer search request comprises at least one query category and at least one keyword associated with the query category.

4. The method of claim 3, wherein matching the commercial offer search request comprises matching the at least one keyword associated with the query category with a commercial offer record that associates the keyword with the query category.

5. The method of claim 1, wherein matching the commercial offer search request with a plurality of extracted commercial offer records comprises
converting the extracted commercial offer records into one or more searchable documents;
ranking the searchable documents based on the commercial offer search request.

6. The method of claim 1, wherein the commercial offer records comprise product records.

7. The method of claim 6, wherein the displayed information elements are selected from the group consisting of product name, product price, product image, product rating, product review, and product description.

8. The method of claim 1, further comprising aggregating the extracted commercial offer records with additional commercial offer records formed from a provided information stream.

9. A method for performing a document search, comprising:
receiving at least one document;
selecting extraction parameters based on one or more characteristics of the at least one document;
extracting a commercial offer record from the at least one document using the selected extraction parameters;
matching at least one extracted product record with a commercial offer search query; and
displaying a plurality of information elements from each matching commercial offer record.

10. The method of claim 9, wherein the extraction parameters are selected based on the universal resource locator of the at least one document.

11. The method of claim 9, further comprising aggregating the extracted commercial offer records with additional commercial offer records formed from a provided information stream.

12. The method of claim 9, wherein the at least one document comprises a plurality of documents organized under a parent document.

13. The method of claim 12, wherein selecting extraction parameters comprises selecting extraction parameters based on one or more characteristics of the parent document.

14. The method of claim 9, wherein the at least one document comprises a head site.

15. A system for performing a commercial offer search, comprising:
a document separator for separating HTML and meta information from one or more documents;
a page classifier for identifying commercial offer pages;
an entity extractor for extracting one or more information elements from a commercial offer page and forming a commercial offer record; and
a keyword search component for matching a commercial offer record with a commercial offer query.

16. The system of claim 15, further comprising a web crawler for finding documents for processing by the document separator.

17. The system of claim 15, wherein the entity extractor comprises a plurality of extraction parameter sets, the extraction parameter sets being selectable based on one or more characteristics of a commercial offer page.

18. The system of claim 15, wherein the keyword search component comprises a structured query component for matching a product record based on a query category and an associated keyword.

19. The system of claim 15, further comprising a display component for displaying information elements from multiple product records in a gallery.

20. The system of claim 15, further comprising a field mapper for converting one or more commercial offer records into a searchable document.
